(19) United States
(12) Patent Application Publication
(10) Pub. No.: US 2017/0114671 A1
(43) Pub. Date: Apr. 27, 2017

(54) GAS TURBINE EXHAUST SYSTEM

(71) Applicant: Siemens Aktiengesellschaft, München (DE)

(72) Inventor: Jose L. Rodriguez, Lake Mary, FL (US)

(21) Appl. No.: 15/127,085

(22) PCT Filed: Apr. 10, 2014
(86) PCT No.: PCT/US14/33582

§ 371 Date: Sep. 19, 2016

(51) Int. Cl. F01D 25/30; F01K 7/16; F02C 3/04

(52) U.S. Cl. CPC F01D 25/30; F02C 3/04; F01K 7/16; F05D 2220/72

(57) ABSTRACT

A power generation system (10). Stationary and rotatable blades (34, 37) are positioned about a rotor (8) to receive exhaust gas (46) from a combustor (6) and to impart an axial velocity component. A section of ductwork (48) is positioned to receive the exhaust gas and has a central transition portion (80t) into which the rotor extends. A spiral portion (80s) of the ductwork comprises a helically shaped flow section (80) extending outwardly from the central portion to provide a helical section of the flow path to carry the exhaust gas away from the central portion. A portion of the flow path along the helically shaped flow section may have an area in cross section which increases as a function of position along the flow path. The spiral portion is positioned to redirect the exhaust in a direction orthogonal to the rotor.

### FIELD OF THE INVENTION

This invention relates to power generation systems and, more particularly, to systems incorporating gas turbine engines. While not limited to such, the invention is of particular relevance to combined cycle systems.

### BACKGROUND OF THE INVENTION

Modern power generation systems, whether single cycle or combined cycle typically employ a gas turbine engine. It is conventional to provide a relatively long, straight diffuser to recover the pressure of the hot exhaust gas exiting the turbine blade section and flowing toward a HRSG or exhaust stack. This has required use of so called hot struts (i.e., structural members which are positioned in the flow path of the hot exhaust gas) to support the diffuser and to transfer the rotor load to the ground. Such placement of struts inside the diffuser and in the main flow path of the exhaust gas contributes to pressure losses and introduces disturbances in the gas flow. Additional performance concerns and design complexities result when addressing thermal concerns. That is, the designs often require provision of cooling air as well as shielding about the struts to limit the temperature of these components or use of much more costly materials. The operating temperatures also subject the aft rotor bearing (i.e., positioned downstream of the turbine blade section) to high levels of heat which have been offset with cooling air injected through ports in the struts or an additional set of struts located downstream. The amount of cooling air is limited by the number of struts which can be placed in the flow path without creating unacceptable blockage of the gas flow. An inability to sufficiently cool the components can also create rotor eccentricity, cracks or structural failures.

Other concerns in flow dynamics also result from conventional designs. For example, the transition from annular to circular flow when the hot gas moves from the blade section into the HRSG requires a dump-type diffuser section. Aside from introducing inefficiency, this must be followed by a very long diffuser to remove undesirable flow components and ensure uniform flow into the HRSG. Some diffuser designs incorporate very long center bodies so the flow speed becomes very slow before reaching the dump-type diffuser. This reduces losses, but creates other problems, including vibration, increased cost due to added materials and a need for placing additional support struts in the hot gas flow path.

Still another feature of existing design configurations is the requirement to mitigate or substantially eliminate swirl in exhaust gas exiting the blade section at base load. It is noted that systems designed to reduce swirl at base load exhibit swirl at part load giving rise to inefficiencies, unsteadiness in the flow and problems that may cause parts to fail in the HRSG. Generally, reductions in swirl and imposition of other requirements adversely impact the performance of the gas turbine engine and introduce complexities which impact maintenance and cost. For example, with the aft rotor bearing positioned in the flow path it is more vulnerable to effects of heat and requires more maintenance. Further, the requirements for long diffusers render it more difficult to access the aft rotor bearing for maintenance.

It is desirable to find alternate designs which eliminate these disadvantages. Otherwise, efforts to improve performance in the exhaust systems of these engines will, at best, be difficult.

### BRIEF DESCRIPTION OF THE DRAWINGS

The invention is explained in the following description in view of the drawings that show:

FIG. 1 is a schematic diagram illustrating a gas turbine engine and other components in a power generation system incorporating the invention;

FIG. 2 is a view taken along a rotor axis to illustrate features of the gas turbine engine of FIG. 1 and associated exhaust diffusion ductwork;

FIG. 3 provides a view in cross section taken through the rotor axis to illustrate a section of exhaust diffusion ductwork in the form of a volute having a central transition portion and a spiral portion.

FIG. 4 is an elevation view of the exhaust diffusion ductwork in relation to a HRSG shown in FIG. 1.

FIG. 5 is a schematically illustrates a portion of an active blade clearance control system;

FIG. 6 schematically illustrates a rotor adjustment subsystem of the blade clearance control system;

FIG. 7 is an axial view of a series of clearance sensors positioned about an exemplary row of blades in the turbine section of the engine shown in FIG. 2; and

FIGS. 8A and 8B are plan views of a plant layout according to the invention.

Like reference numbers are used throughout the figures to denote like components. Numerous components are illustrated schematically, it being understood that various details, connections and components of an apparent nature are not shown in order to emphasize features of the invention. Various features shown in the figures are not shown to scale in order to emphasize features of the invention.

### DETAILED DESCRIPTION OF THE INVENTION

Before describing in detail exemplary methods, systems and components according to embodiments of the invention, it is noted that the present invention resides primarily in a novel and non-obvious combination of components and process steps. So as to not obscure the disclosure with details that will be readily apparent to those skilled in the art, certain conventional components and steps have been omitted or presented with lesser detail, while the drawings and the specification describe in greater detail elements and steps pertinent to understanding the invention. Further, the following embodiments do not define limits as to structure or method according to the invention, but provide examples which include features that are permissive rather than mandatory and illustrative rather than exhaustive.

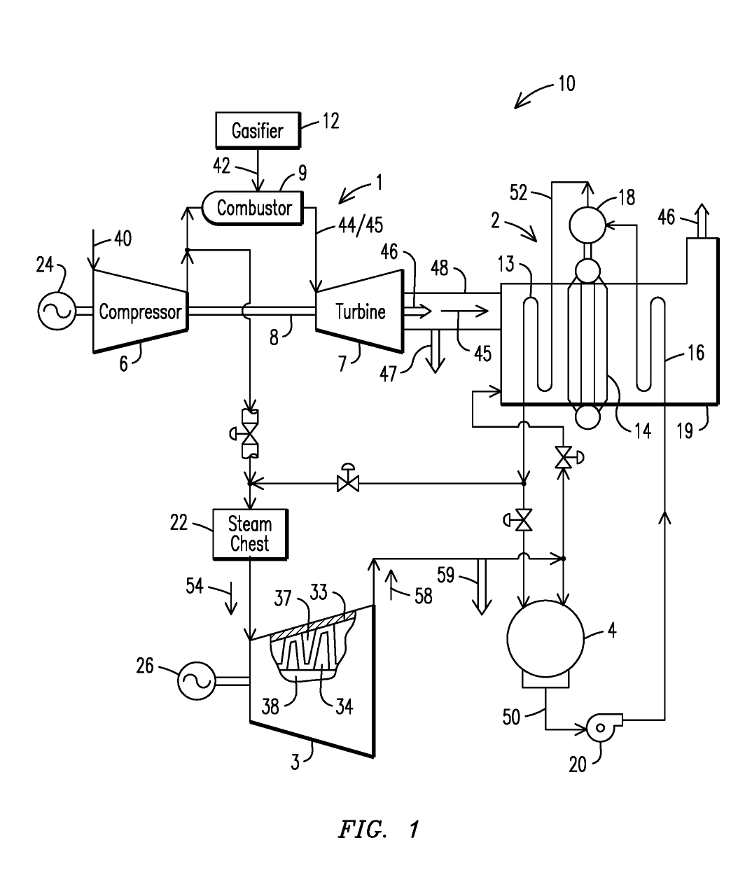

With reference to FIG. 1 there is shown an exemplary Integrated Gasification Combined Cycle (IGCC) power generation system 10 incorporating principles of the invention. While the invention is described with reference to an IGCC plant, the concepts are applicable to many power systems applications including combined cycle systems generally, as well as single cycle systems which utilize gas turbine engines. The system 10 includes numerous well-known components, including a gas turbine engine 1, a heat recovery steam generator 2 (“HRSG”), a steam turbine 3, and a condenser 4. The gas turbine engine 1 includes a compressor 6, a turbine blade section 7 coupled to a rotor 8 and a combustor 9. The rotor 8 connects the blade section to transfer power to the compressor 6 and an electrical generator 24. The combustor receives fuel from a source which, in this embodiment, is a gasification system 12.

The HRSG 2 includes a superheater 13, an evaporator 14, a steam drum 18, and an economizer 16. The steam turbine 3 includes a rotor 38 mounted for rotation within a casing 33 so as to form a flow path wherein steam travels across a plurality of the rotating blades 34 and stationary vanes 37 to transfer power.

In operation, the compressor 6 inducts ambient air 40 to provide a source of heated, compressed air which is sent to the combustor 9 where it reacts with a gaseous fuel 42 (e.g., syngas received from the gasification system 12). Hot compressed gas 44 produced in the reaction is directed along an exhaust flow path 45 to the turbine blade section 7 where it expands to produce mechanical power in the rotor 8 that drives the compressor and the generator 24. The expanded gas 46 is then exhausted from the turbine blade section 7, following the flow path 45 through ductwork 48. The ductwork 48 functions as a diffusion section, while also directing the expanded exhaust gas 46 to the HRSG 2. In the HRSG the gas 46 flows successively over the superheater 13, the evaporator 14 and the economizer 16. A portion 47 of the expanded gas may also be directed to other components, such as a high temperature heat exchanger in the gasification system. After flowing through the HRSG 2, the cooled, expanded gas 46 is then discharged to atmosphere via a vertical exhaust stack 19. In the HRSG 2, the expanded gas 46 transfers a considerable portion of its heat to the feed water, cooling the gas and transforming the feedwater into steam.

In addition to the expanded gas 46 discharged by the gas turbine 1, the HRSG 2 receives a flow of feed water 50 from the condenser 4 that has been pressurized by a pump 20. The feed water first flows through the heat transfer tubes of the economizer 16, where its temperature is raised to near the saturation temperature. The heated feedwater from the economizer 16 is then directed to the steam drum 18. From the steam drum 18, the water is circulated through the heat transfer tubes of the evaporator 14 which converts the feed water into saturated steam 52 which is then directed to the superheater 13, where the steam temperature is raised into a superheated region and then provided to a steam chest 22 that distributes the steam to the inlet of the steam turbine 3.

In the steam turbine 3, the steam 54 flows through the casing 33 and over rows of rotating blades 34 and stationary vanes 37, only a few of which are shown in FIG. 1. In this movement the steam 54 expands and generates shaft power that drives the rotor 38 which, in turn, drives a second electrical generator 26. Alternately, the steam turbine rotor 38 could be integrally formed along the gas turbine rotor 8 to drive a single electrical generator. The expanded steam 58 exhausted from the steam turbine 3 is directed to the condenser 4 and eventually returned to the HRSG 2. A portion 59 of the expanded steam 58 may be diverted to a low temperature heat exchanger in the gasification system 12.

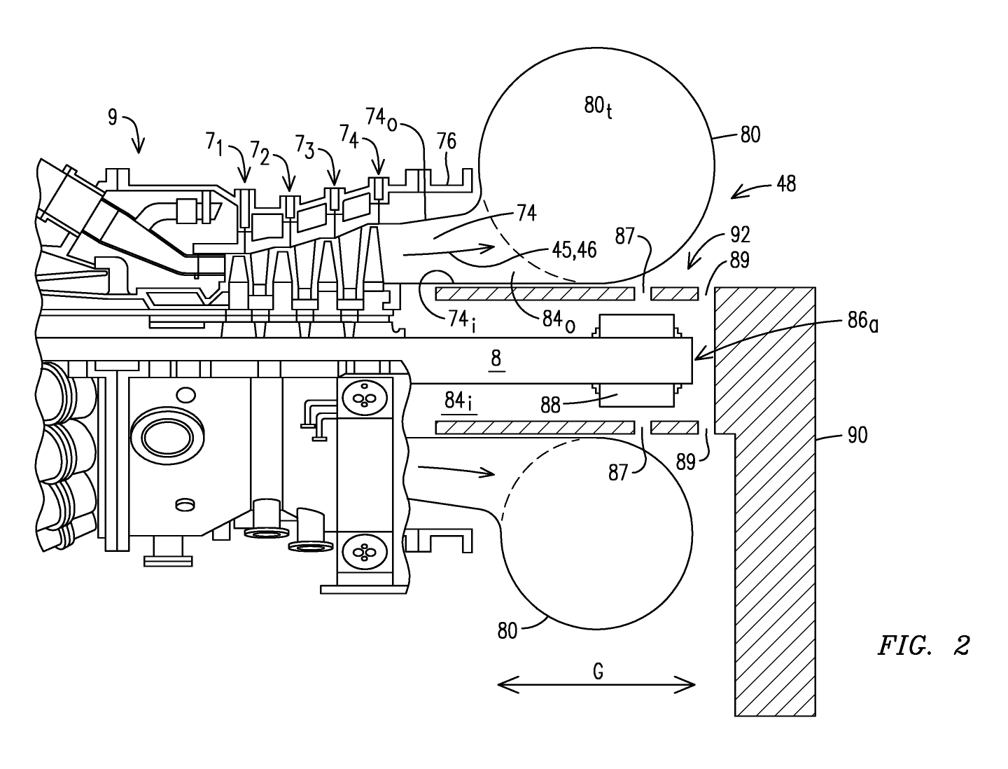

FIG. 2 is a partial cut-away view of the gas turbine engine 1 positioned over a horizontal ground plane, G, illustrating details of an exemplary turbine section and exhaust ductwork. The turbine blade section 7 includes four rows 7₁, 7₂, 7₃, 7₄ of stationary and rotatable blades where row 7₄ is the last, most downstream row. Movement of the exhaust gas 46 through the blade rows generates swirl (i.e., a rotating movement of the gas about the rotor), in addition to the axial movement along the flow path 45. Conventionally, turbine sections remove the rotating component before the gas flows into a diffuser section to recover static pressure. For example, air foil shapes in the last row of the blade section are typically designed to reduce or eliminate the swirl before or as the exhaust gas 46 exits the blade section. This removal of swirl has provided a substantially axial flow to the diffuser section of a conventional exhaust. Embodiments of the invention are distinguished over this arrangement, in part because the turbine section 7 does not include features designed to mitigate swirl. Specifically, neither the last blade row, e.g., blade row 7₄, nor any of the other blade rows is designed to remove swirl which otherwise results from movement of the exhaust gas there through.

The blade section 7 and exhaust ductwork 48 are designed to recover static pressure without experiencing losses which result from removing or minimizing the swirl angle, i.e., the angle between the circumferential velocity vector and the axial velocity vector of the gas flow. As used herein, the term circumferential means along a chosen circumference corresponding, for example, to an outer boundary or other perimeter. The perimeter may be a path defined by rotating blade tips or by the interior diameter of a surface along the turbine casing, e.g., a blade shroud. A minimum circumferential velocity is a velocity which may be expressed relative to the axial flow velocity of the exhaust gas, referred to as the swirl angle. An exemplary minimum swirl angle for the system 10 is 30°.

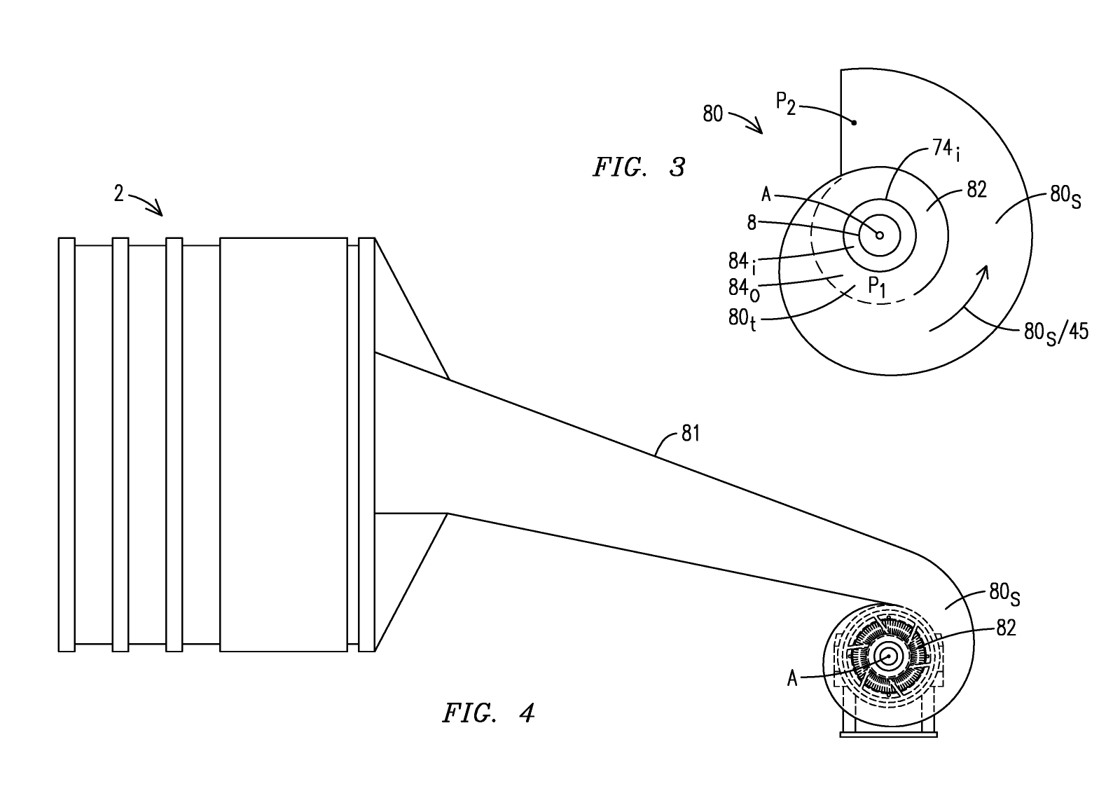

With reference to FIGS. 2 and 3, the ductwork 48 defining a portion of the flow path between the blade section 7 and the HRSG 2 receives the rotating component of the exhaust gas 46 into a relatively short diffuser section 74 that connects the blade section 7 to a section 80 of the ductwork 48 in the form of a volute: having (i) a central transition portion 80t into which the rotor 8 extends and which receives the hot exhaust gas and (ii) a spiral portion 80s. See the cross sectional elevation view of FIG. 3, taken through the axis, A, about which the rotor 8 turns.

The diffuser section 74 has a radially inner wall 74ᵢ, which extends axially about the rotor 8 and into the central transition portion 80t of the section 80 of the ductwork 48. The inner wall 74ᵢ isolates the hot exhaust gas 46 from the rotor and associated components such as the rotor bearing. A radially outer wall 74o of the diffuser section 74 extends along an inner side of the engine casing 76 and away from the rotor, giving the diffuser section 74 the shape of the frustum of a regular cone. An advantageous feature is that a spiraling segment of the flow path 45 extends along the spiral portion 80s in a plane orthogonal to the direction of the flow exiting the blade section 7. See FIG. 4. With the blade section 7 generating a minimum swirl velocity, e.g., 30 degrees, the section 80 is matched to receive the circumferential velocity of the swirl to optimally recover the static pressure. After exiting the turbine section 7, the swirl angle of the expanded exhaust gas 46 continues with minimum disruption into the spiral portion 80s of the section 80.

One embodiment of the section 80, in the form of a volute, is the scroll-shaped duct section shown in FIG. 3. The portion of the helical flow path 45 within the spiral portion 80s of this section 80 extends away from a central axis of the section 80 which is coincident with the axis, A. The area in cross section of the portion of the path 45 bounded by the spiral section 80s increases as the path spirals outward from this axis. For example, the area in cross section of the spiral portion 80s about a first position P1 near the opening 82 is smaller than the area in cross section of the path 45 about a second position P2 near where the spiral portion 80s transitions into a conical diffuser 81 shown in FIG. 4.

The section 80 has a central opening 82 about the axis, A, which is formed in two concentric inner and outer annular volumes 84i, 84o. The rotor 8 and associated mechanical components extend into the inner volume 84i while the outer volume 84o is positioned in the flow path 45 to provide transition of the hot exhaust gas 46 from the diffuser section 74 into a spiral portion 80s along which the flow path 45 extends within the section 80. The inner wall 74i of the diffuser section 74 extends into the spiral portion 80, thereby isolating the mechanical components positioned within the inner volume 84i from the hot exhaust gas 46 flowing through the outer volume 84o. The axial view of FIG. 3 illustrates the relationships of the inner and outer volumes 84i, 84o to the portion of the flow path along the spiral portion 80s of the section 80. The annular outer volume 84o is shown in the figure with a circular shape formed with the combination of a solid line segment and a dashed line, the dashed line indicating that the outer volume 84o is open to the spiral portion 80s of the section 80.

Referring again to FIG. 2, the aft, i.e., downstream, end 86ₐ of the rotor 8 is shown journaled in a cold bearing 88. The rotor end 86ₐ and the bearing 88 are both positioned outside the flow path 45 and, by way of example, are positioned within the inner volume 84i with the diffuser section inner wall 74i isolating the bearing and the rotor end from the flow path. Although not shown, the rotor end 86ₐ and the bearing 88 may be further isolated from the hot flow path by insulation material or may receive cooling air that comes in via the struts or a second set of struts downstream.

The associated load of the engine 1 is supported by a post 90 which extends vertically upward from the ground plane. A bearing housing 92, which may be integrally formed with the post 90, extends in a horizontal direction from the post to provide a repository which contains the bearing 88 and the rotor end 86ₐ. In contrast to conventional designs, the post 90, the bearing housing 92, the bearing 88 and the rotor aft end 86ₐ are all positioned outside the flow path 45 instead of positioning all of these components and struts within the engine casing 76 and in the path of the hot exhaust gas flow. By positioning this structure outside of the flow path design features to sustain hot struts and bearings are reduced or eliminated.

During operation of the engine 1 the annular outer volume 84, serves as a transition segment in the flow path, leading into the spiral portion 80s. This facilitates low impedance movement of the exhaust gas 46 into the spiral portion 80s along which the flow path 45 extends within the section 80. There is an uninterrupted continuation of the circumferential velocity component of the exhaust gas 46 as the gas flows through the spiral portion 80s toward the exhaust stack 19.

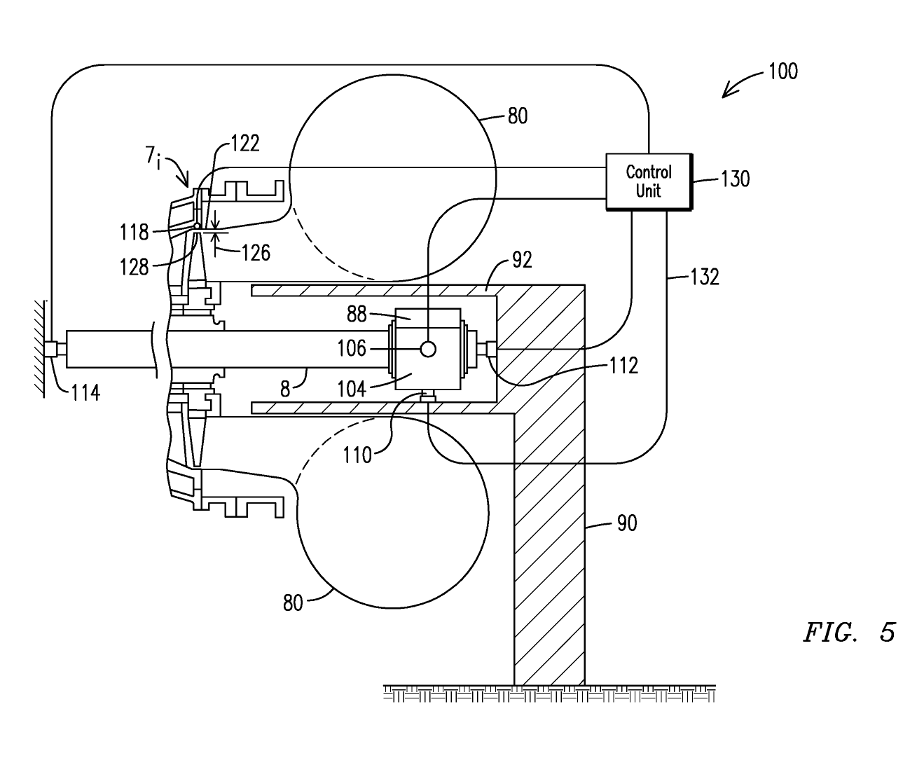

According another embodiment of the invention FIGS. 5 and 6 illustrate a closed loop active blade clearance control system 100 which is advantageously based on positioning of the bearing 88, the aft rotor end 86ₐ, the bearing housing 92 and the engine support post 90 outside and away from the flow path as generally illustrated in FIG. 2 such that the bearing is not surrounded by hot air and subjected to a high temperature environment which would otherwise result as heat is transferred from the exhaust gas 46 to the bearing. In the illustrated embodiment, at least an aft portion of the bearing 88 is open to the surrounding atmosphere and relatively cool air, instead of ductwork surrounding the flow path. This configuration simplifies delivery of relatively cool oil to the bearing 88 as well as provision of ambient air into the housing 92. By way of example, FIG. 2 illustrates pairs of ports 87, 89. An oil line (not shown) can carry the oil through one of the ports 87 to the bearing 88 and back out through another one of the ports 87. The other ports 89 can permit passive or active flow of ambient air into and out of the bearing housing 92 to facilitate cooling.

FIG. 6 provides an end view of the rotor end 86ₐ and bearing 88 to illustrate incorporation of a rotor adjustment subsystem 100a of the blade clearance control system 100 into the bearing housing 92. A U-shape moveable plate 104, having at least two degrees of freedom, is interposed between the bearing housing 92 and the bearing 88. As shown in the figure, the plate 104, having a radius of curvature which matches that of the bearing, may be fixed against the rotor bearing 88 so that displacement of the plate relative to the bearing housing 92 results in movement of both the bearing 88 and the rotor 8 relative to the housing 92. The plate is rigidly coupled to the rotor bearing 88 and moveably coupled to the bearing housing for varied positioning therein. With the plate 104 having two degrees of freedom, forces can be applied against the plate to displace the rotor 8 in any direction within a plane, e.g., in a plane orthogonal to the rotor axis. Movement in each direction may be effected with an electric or hydraulic actuator. For example, along a horizontal axis parallel to the ground plane, G, two horizontal hydraulic actuators 106, 108 may be positioned on opposing sides of the plate 104 so each may displace the plate in one of two opposing directions along the horizontal axis. A third hydraulic actuator 110, positioned under the plate 104, can elevate the plate (e.g., along a vertical direction relative to the ground plane) or permit controlled lowering of the plate toward the ground plane. Although illustrated as having a U-shape with a radius of curvature that conforms to an exterior surface of the bearing 88, the plate 104 may be flat or of another shape and affixed to the bearing 88.

With reference also to FIG. 5, a fourth actuator 112 is positioned against the aft rotor end 86ₐ to displace the rotor 8 in an upstream axial direction. Similarly, a fifth actuator 114 is positioned against the fore, i.e., upstream, end 86_{f} of the rotor 8 to displace the rotor in a downstream axial direction. For simplicity of illustration, the bearing housing and bearing in which the fore rotor end 86_{f} are not shown in FIG. 5.

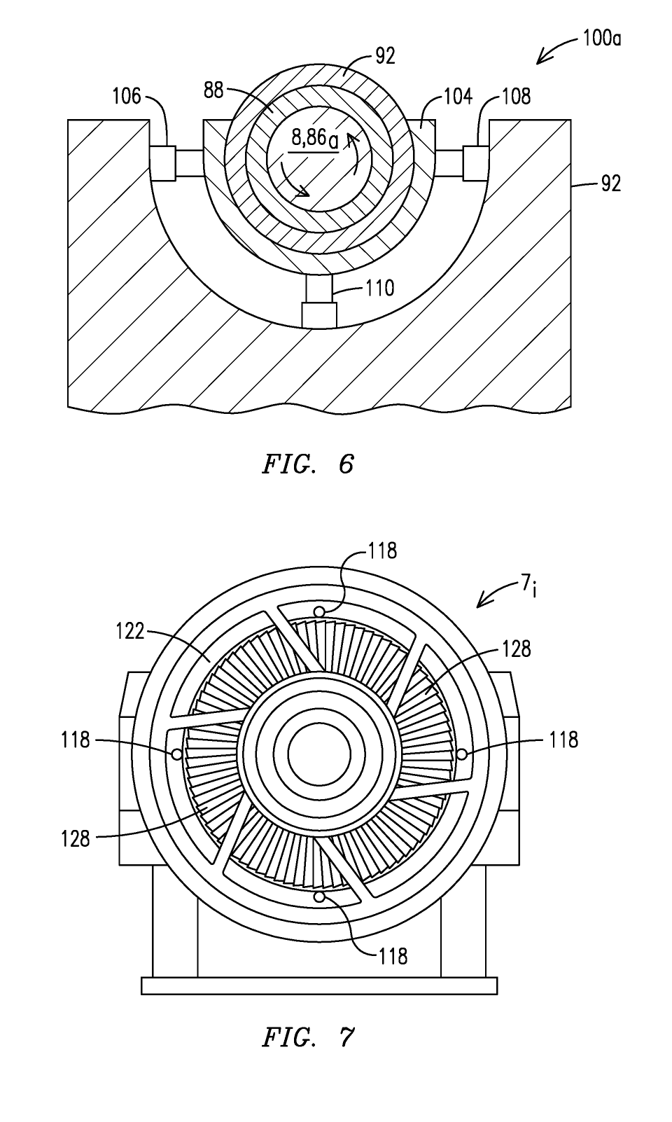

The system 100 includes a plurality of clearance sensors 118. In one embodiment a set of sensors is placed along each of multiple blade rows (e.g., rows 7₁ and 7₂) to measure clearances between blade tips and a shroud. As illustrated schematically in FIG. 7 for one such row, 7ᵢ, four clearance sensors 118 are mounted ninety degrees apart along a shroud 122 to measure clearance 126 between the blade tips 128 and the shroud 122 in the row. Additional sensors may be positioned along compressor stages as well. The sensors 118 may employ known technologies such as capacitor-based blade tip clearance measurement or optical blade tip clearance measurement.

The system 100 further includes a controller 130 which receives clearance information from the sensors 118 via data lines 132 or rf transmission from each of the multiple sensors 118. The controller periodically processes data from all sensors, including those monitoring the compressor stages, to determine clearances and apply criteria to determine whether to adjust any of the clearances. Adjustment is effected by the controller providing a feedback loop which sends adjustment signals to one or more of the actuators until determinations of clearances confirm that criteria are met.

By employing ductwork having a central transition portion to redirect the flow, followed by an expanding spiral shaped duct (e.g., in the form of a volute) which acts as a diffuser, the hot gas flow can be turned ninety degrees, i.e., redirected with respect to the axial flow exiting the blade section. With this arrangement, the support structure need not be in the flow path of the hot exhaust gas. This removes flow interference and cooling requirements. It extends the life of numerous components and improves operational efficiencies.

With positioning of the bearing in the center region of the spiral shaped duct or beyond the duct (e.g., with the spiral shaped duct positioned between the bearing and the blade section), the bearing becomes fully and more easily accessible, reducing maintenance costs. Also, to the extent cooling air is beneficial for maintaining the aft bearing, this can be provided directly to the components without adversely affecting the gas turbine performance. With elimination of struts from the flow path 45 there is improved performance of the engine at partial load because high losses due to the struts are eliminated.

Another feature, resulting from employment of a spiral shaped duct by which the hot gas flow can be turned ninety degrees is relevant to both simple cycle and combined cycle power generation systems. In simple cycle systems the exit from the spiral shaped duct can be efficiently integrated with the exhaust stack, thereby reducing the overall size and material cost of the plant foot print. In combined cycle power generation systems, the spiral shaped duct can be integrated with the diffuser connecting the flow to the HRSG such as shown in FIG. 4. That is, use of a spiral shaped duct in the form of a volute provides an efficient way to convert the annular flow exiting the blade section into a uniform pipe flow, thereby reducing system losses and minimizing transient unsteadiness which results from an abrupt transition as provided with a dump-type diffuser. Designs according to the invention preserve high levels of exit swirl generated in the turbine section, thereby allowing for an improved turbine design which results in improved operational efficiency.

Still another feature, resulting from employment of a spiral shaped duct by which the hot gas flow can be turned ninety degrees before entering the HRSG, is that the layout area of a combined cycle power generation system can be made more compact. In a conventional layout for a combined cycle power generation system the combustor, the blade section, the diffuser stages and the HRSG are all co-aligned with the rotor axis. As shown in the elevation view of FIG. 4, the invention enables the exhaust diffusion ductwork, e.g., the diffuser 81, to extend in a direction perpendicular to the axis, A, about which the rotor 8 turns. With this arrangement, the HRSG 2 can be positioned to receive the hot exhaust gas 46 travelling in a direction perpendicular to the axis, A, and the HRSG need no longer be coaxially aligned with the rotor axis, A.

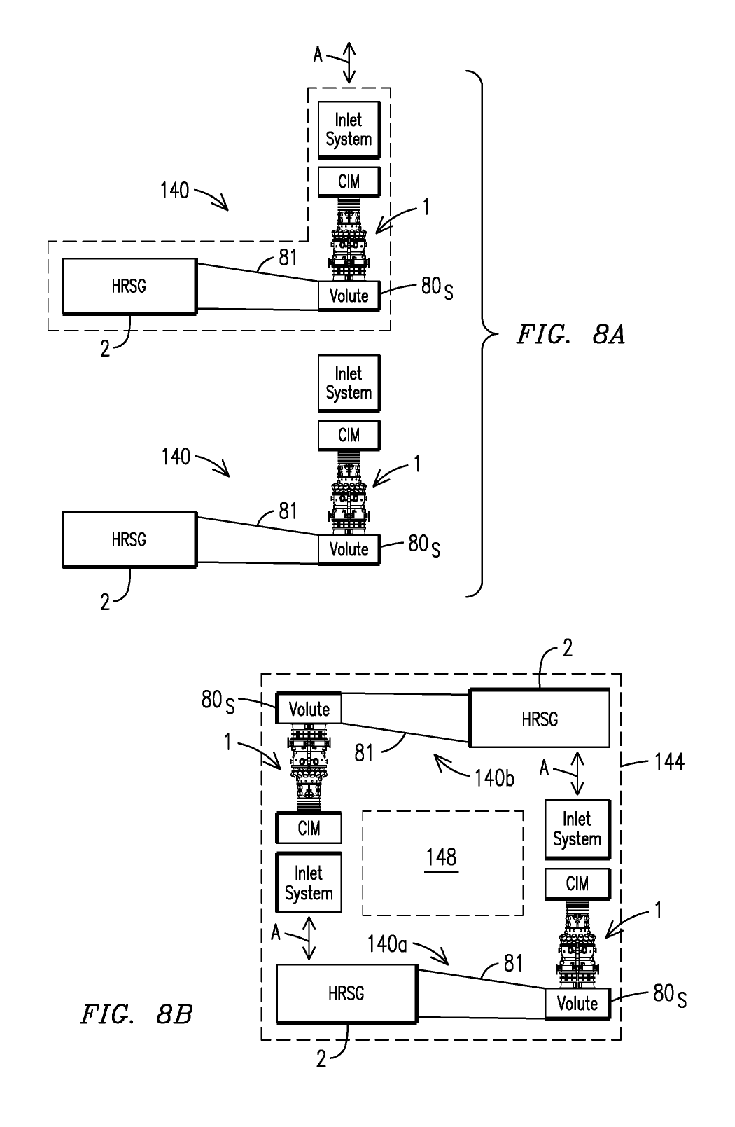

In the embodiment shown in the views of FIGS. 8, the spiral section 80s extends along a plane, in a direction perpendicular to and away from the axis, A, with the diffuser 81 completing the path for exhaust gas 46 to reach the HRSG 2. Also, as shown in FIG. 3, with insertion of a helical flow path, e.g., by means of a spiral section, an exhaust gas having swirl need not travel in a path along a single plane perpendicular to the axis, A. Rather, both the spiral section 80s and the diffuser 81 can be modified to follow a curved path which is not restricted to a plane perpendicular to the axis, A. This permits placement of the HRSG 2 at other angles besides ninety degrees with respect to the axis, A. By way of example, the spiral section 80s may bend out of a plane perpendicular to the axis, A and the diffuser may also include a bend so that the exhaust gas may travel along a curved path which permits placing the HRSG at an arbitrary position instead of in a ninety degree direction with respect to the axis, A.

FIG. 8A illustrates an embodiment where the diffuser carries the exhaust gas 46 in a direction that is perpendicular to the axis, A. This “L” layout configuration enables clustering of multiple combined cycle systems 140, each comprising a gas turbine engine 1, a HRSG 2 and a steam turbine 3, in a manner that reduces the ground area dedicated to plant equipment. See, for example, the simplified schematic arrangement shown in FIG. 8B, in which two combined cycle systems 140a, 140b are positioned in a rectangular pattern 144 with each having a rotor axis, A, parallel to the other axis, A. Further, each system includes a diffuser 81 extending in a direction perpendicular to each axis, A so that the two HRSGs are diagonally opposite one another while the two gas turbine engines 1 (each including a turbine blade section 7) are also diagonally opposite one another.

A center section 148 of the rectangular pattern 144, surrounded by the pair of combined cycle systems 140a, 140b, is used to consolidate operational support equipment including, for example, boilers, pumps, and reservoirs of cooling oil and air supplies proximate to the turbine engines 1 and the HRSG 2.

According to one series of embodiments a power generation system has been described, in which a gas turbine engine includes a combustor, a blade section, and a rotor having a first end journaled in a bearing. A blade section includes multiple rows of stationary and rotatable blades to receive hot exhaust gas travelling along a flow path from the combustor to turn the rotor. The blade section imparts an axial velocity component to the exhaust gas and a rotational velocity component in a first circumferential direction about a circumference bounding a portion of the flow path downstream of the blade section. The blade section is designed to provide a minimum swirl angle between the circumferential and axial velocities along the circumference of at least thirty degrees. The swirl angle may be a minimum of thirty five degrees or a minimum of forty degrees. A stack is positioned to receive exhaust gas which travels along the flow path from the blade section. The stack is oriented to vent exhaust in a vertical direction above the ground plane. A section of ductwork includes (i) a central transition portion into which the rotor extends, which portion receives the hot exhaust gas, and (ii) a spiral portion comprising a helically shaped flow section extending outward from the central portion to provide a helical section of the flow path to carry the hot exhaust gas away from the central portion. A portion of the flow path along the helically shaped flow section has an area in cross section which increases as a function of position along the flow section.

An embodiment of a power generation system has also been described, having a combustor, a rotor, a plurality of stationary and rotatable blades and a section of exhaust ductwork. The stationary and rotatable blades are positioned about the rotor to receive exhaust gas from the combustor and impart to the gas an axial velocity component relative to a first direction of flow away from the blades. The section of ductwork includes a central transition portion and a spiral portion. The rotor extends into the central transition portion. The central transition portion is positioned to receive the hot exhaust gas flowing from the blade section. The spiral portion includes a helically shaped flow section extending outward from the central portion to provide a helical section of the flow path. This carries the hot exhaust gas away from the central portion. A portion of the flow path along the helically shaped flow section has an area in cross section which increases as a function of position along the flow section. The spiral portion is positioned to redirect the exhaust in a direction orthogonal to the first direction of flow. A diffuser may be positioned between the plurality of blades and the central transition portion of the ductwork. A diffuser may also be positioned between the spiral portion of the ductwork and the HRSG.

According to an embodiment of a related method for improving performance in a power generation system having a gas turbine engine, a minimum swirl angle of thirty degrees is imparted to exhaust gas exiting a blade section of the engine along a flow path. A section of ductwork is provided having a central transition portion and a spiral portion. The rotor extends into the central transition portion. The central transition portion also receives the hot exhaust gas. The spiral portion includes a helically shaped flow section extending outward from the rotor axis. The section of ductwork is positioned to provide a helical section in the flow path to carry hot exhaust gas away from the central transition portion in a direction orthogonal to the rotor axis.

According to another series of embodiments, a gas turbine engine includes a control system to adjust a clearance between rotating and stationary components. The engine includes a rotor positioned for rotation about an axis, a turbine blade section, and a bearing housing. The turbine blade section has multiple rows of stationary and rotatable blades positioned about the rotor to receive exhaust gas travelling along a flow path to turn the rotor. The rotor has an aft end extending beyond the flow path. The bearing housing is positioned outside the flow path. A bearing is positioned in the housing and outside the flow path, with the aft end of the rotor journaled in the bearing. A post is positioned outside the flow path to support the bearing housing, the aft rotor end and other components of the engine. An adjustment system is positioned outside the flow path providing at least two degrees of freedom to alter positioning of the aft rotor end and thereby alter clearance between a rotatable blade tip and a stationary component.

According to still another series of embodiments, a clearance adjustment system has been described for use in a power generation system comprising a gas turbine engine having a combustor, a blade section, a bearing and a rotor extending along a central axis. The rotor has a first end journaled in the bearing, and the blade section includes multiple rows of stationary and rotatable blades positioned about the rotor to receive an exhaust gas traveling along a flow path from the turbine combustor. The flow path constrains flow of the exhaust gas within predetermined bounds. The clearance adjustment system includes a structure positioned outside the bounds of the flow path to support the bearing and the rotor first end. An adjustable plate is positioned outside the bounds of the flow path, between the rotor first end and the support structure. The plate is mechanically coupled to the rotor such that displacement of the plate changes clearance between tips of rotatable blades and one or more stationary components in the blade section.

The invention has been illustrated with reference to example embodiments but may be applied in a variety of other ways. Many equivalents, alternatives and modifications will be apparent without departing from the invention. While various embodiments of the present invention have been shown and described herein, these are provided by way of example only. Numerous variations, changes and substitutions may be made without departing from the invention herein. Accordingly, it is intended that the invention be limited only by the spirit and scope of the appended claims.

1.-24. (canceled)

25. A power generation system positioned along a horizontal ground plane, comprising:
a combustor;
a rotor;
a blade section comprising a plurality of stationary and rotatable rows of blades positioned about the rotor to receive exhaust gas from the combustor and impart to the gas an axial velocity component relative to a first direction of flow away from the blades;
a section of the ductwork having (i) a central transition portion into which the rotor extends and positioned to receive the hot exhaust gas and (ii) a spiral portion comprising a helically shaped flow section extending outward from the central transition portion to provide a helical section of the flow path to carry the hot exhaust gas away from the central transition portion, wherein a portion of the flow path along the helically shaped flow section has an area in cross section which increases as a function of position along the flow section, wherein the spiral portion is positioned to redirect the exhaust in a direction orthogonal to the first direction of flow.

26. The power generation system of claim 25 wherein the spiral portion of the ductwork is positioned to provide a flow path between the plurality of blades and a HRSG.

27. The power generation system of claim 26 wherein a diffuser is positioned between the plurality of blades and the central transition portion of the ductwork.

28. The power generation system of claim 26 wherein a diffuser is positioned between the spiral portion of the ductwork and the HRSG.

29. The power generation system of claim 25, wherein:
the rotor has a first end journaled in a bearing above the ground plane, and the blade section is:
(i) positioned about the rotor to receive hot exhaust gas travelling along a flow path from the combustor to turn the rotor,
(ii) configured to impart to the flow of exhaust gas an axial velocity component and a rotational velocity component in a first circumferential direction about a circumference bounding a portion of the flow path downstream of the blade section, and
(iii) designed to provide a minimum swirl angle between the circumferential and axial velocities along the circumference of at least thirty degrees, the system further comprising:
an exhaust stack coupled to receive exhaust which travels along the flow path from the blade section, the stack oriented to vent received exhaust in a vertical direction above the ground plane.

30. The power generation system of claim 29 wherein the portion of the flow section having an increasing area in cross section provides for diffusion of flowing exhaust gas, decreasing the speed at which the gas flows along the path.

31. The power generation system of claim 29 wherein none of the rows of blades includes features to reduce the swirl angle.

32. The power generation system of claim 29 wherein the helical flow path spirals in the first circumferential direction consistent with the direction of the rotational velocity component when the exhaust gas exits the blade section.

33. The power generation system of claim 29 wherein the rotor extends into or through the volute.

34. The power generation system of claim 29 further including a support, with the bearing in which the rotor first end is journaled mounted on the support, wherein the bearing and the support are both positioned outside of the flow path.

35. The power generation system of claim 33 wherein the helically shaped flow section is a volute positioned between the bearing and the blade section.

36. The power generation system of claim 29 wherein the rotor first end extends into the volute.

37. The power generation system of claim 36 further including a support for the bearing and the rotor first end in which the rotor first end is journaled, wherein the bearing and the support are both positioned outside of the flow path.

38. The power generation system of claim 37 wherein the volute is positioned between the bearing and the blade section.

39. The power generation system of claim 29 further including a diffuser positioned between the blade section and the volute.

40. The power generation system of claim 29 wherein the power generation system is a combined cycle power generation system comprising a steam turbine and a heat recovery steam generator (HRSG) coupled to receive the flow of exhaust gas from the volute, the system further including a conical diffuser positioned between the volute and the HRSG.

41. The power generation system of claim 29 wherein the blade section is designed to provide a minimum swirl angle between the circumferential and axial velocities along the circumference of at least thirty five degrees.

42. The power generation system of claim 29 wherein the blade section is designed to provide a minimum swirl angle between the circumferential and axial velocities along the circumference of at least forty degrees.

43. The power generation system of claim 29 further including a HRSG and a diffuser positioned between the spiral portion of the ductwork and the HRSG.

44. A method for improving performance in a power generation system comprising a gas turbine engine having a rotor aligned with a horizontal axis, comprising:
imparting a minimum swirl angle of thirty degrees to exhaust gas exiting a blade section of the engine along a flow path;
providing a section of ductwork (i) having a central transition portion into which the rotor extends and to receive the hot exhaust gas and (ii) having a spiral portion comprising a helically shaped flow section extending outward from the rotor axis; and
positioning the section of ductwork to provide a helical section in the flow path to carry hot exhaust gas away from the central portion in a direction orthogonal to the rotor axis.
